(19) United States
(12) Patent Application Publication
(10) Pub. No.: US 2016/0232805 A1
(43) Pub. Date: Aug. 11, 2016

(54) METHOD AND APPARATUS FOR DETERMINING PATIENT PREFERENCES TO PROMOTE MEDICATION ADHERENCE

(71) Applicant: Xerox Corporation, Norwalk, CT (US)

(72) Inventors: GEORGE A. GIBSON, Fairport, NY (US); Karen M. Braun, Fairport, NY (US)

(21) Appl. No.: 14/618,862

(22) Filed: Feb. 10, 2015

(51) Int. Cl. G09B 19/00; G09B 5/00; G06N 5/04

(52) U.S. Cl. CPC G09B 19/00; G06N 5/04; G09B 5/00

(57) ABSTRACT

A method, non-transitory computer readable medium, and apparatus for determining one or more patient preferences are disclosed. For example, the method presents a first plurality of images to a patient to correlate a literacy level to the patient, receives a first image selected by the patient, presents a second plurality of images to the patient to correlate a communication modality to the patient, receives a second image selected by the patient, determines the literacy level and the communication modality for the patient based on the first image and the second image, and presents medical information to the patient in accordance with the literacy level and the communication modality.

The present disclosure relates generally to providing information, and, more particularly, to a method and apparatus for determining one or more patient preferences for promoting medication adherence.

### BACKGROUND

Patients who are suffering from various ailments are often prescribed medications to address the underlying diseases and/or to address physical symptoms caused by the underlying diseases. Although most patients are willing to adhere to the instructions (e.g., instructions pertaining to the taking of the medications as to the dosage and frequency) that are provided along with the prescribed medications, inevitably some patients are unwilling to adhere to the instructions. One example is the failure of a patient to finish the full course of a prescribed medication to treat a particular type of chronic illness or an illness that requires long-term medication usage. For example, a normal course of treatment for tuberculosis (TB) may entail the taking of one or more antibiotics for a duration of 6 to 12 months. Since patients who are suffering from early stages of tuberculosis may not even exhibit any symptoms, the patients may erroneously believe such a long period of antibiotic treatment is unwarranted, unnecessary, too costly, and even possibly harmful to them. With such mindset, a patient may not adhere to the instructions prescribed by a doctor and prematurely end the taking of the required medication to treat a very serious disease. The consequences can be quite severe in that the disease is not properly treated for the patient and the premature ending of the treatment may potentially cause the disease to mutate into a more dangerous form where no treatment is even available. Thus, medication non-adherence has wide ranging consequences that extend beyond the individuals who are responsible for not adhering to the instructions of their doctors.

Furthermore, it is believed that up to one third of the patients who are prescribed long-term medication may not have been adequately counseled by their doctors. Thus, one contributing factor that may encourage medication non-adherence is the fact that the patients may not realize the importance of finishing the full course of the medication treatment.

### SUMMARY

According to aspects illustrated herein, there are provided a method, a non-transitory computer readable medium, and an apparatus for determining one or more patient preferences. One disclosed feature of the embodiments is a method that presents a first plurality of images to a patient to correlate a literacy level to the patient, receives a first image selected by the patient, presents a second plurality of images to the patient to correlate a communication modality to the patient, receives a second image selected by the patient, determines the literacy level and the communication modality for the patient based on the first image and the second image, and presents medical information to the patient in accordance with the literacy level and the communication modality.

Another disclosed feature of the embodiments is a non-transitory computer-readable medium having stored thereon a plurality of instructions, the plurality of instructions including instructions which, when executed by a processor, cause the processor to perform operations that present a first plurality of images to a patient to correlate a literacy level to the patient, receive a first image selected by the patient, present a second plurality of images to the patient to correlate a communication modality to the patient, receive a second image selected by the patient, determine the literacy level and the communication modality for the patient based on the first image and the second image, and present medical information to the patient in accordance with the literacy level and the communication modality.

Another disclosed feature of the embodiments is an apparatus comprising a processor and a computer readable medium storing a plurality of instructions which, when executed by the processor, cause the processor to perform operations that present a first plurality of images to a patient to correlate a literacy level to the patient, receive a first image selected by the patient, present a second plurality of images to the patient to correlate a communication modality to the patient, receive a second image selected by the patient, determine the literacy level and the communication modality for the patient based on the first image and the second image, and present medical information to the patient in accordance with the literacy level and the communication modality.

### BRIEF DESCRIPTION OF THE DRAWINGS

The teaching of the present disclosure can be readily understood by considering the following detailed description in conjunction with the accompanying drawings, in which:

FIG. 1 illustrates an example block diagram of a system of the present disclosure;

FIG. 2 illustrates an illustrative screen of a first user interface to solicit a patient preference;

FIG. 3 illustrates an illustrative screen of a second user interface to solicit a patient preference;

FIG. 4 illustrates an illustrative screen of a third user interface to solicit a patient preference;

FIG. 5 illustrates an example flowchart of one embodiment of a method for determining a patient's communication preference for promoting medication adherence; and

FIG. 6 illustrates a high-level block diagram of a computer suitable for use in performing the functions described herein.

To facilitate understanding, identical reference numerals have been used, where possible, to designate identical elements that are common to the figures.

### DETAILED DESCRIPTION

As discussed above, medication non-adherence has wide ranging consequences that extend beyond the individuals who are responsible for not adhering to the instructions of their doctors. It has been noted that medication non-adherence can often be traced to a patient's distrust of the prescribed medication and/or a patient's lack of understanding of the importance of medication adherence. Thus, knowing the underlying cause for the medication non-adherence on an individual basis, i.e., understanding why an individual is not following the instructions associated with the prescribed medication, is often an important first step in addressing medication non-adherence. Through an analysis of a series of questions and response, one may uncover the underlying barrier of a patient's medication non-adherence.

For example, one method may attempt to establish the patients' own perspective, i.e., patient identified barriers, as to why medication adherence was not achieved. Useful questions include (but not limited to):

1) “Are you convinced of the importance of your prescribed medication?”

2) “Do you believe that your prescribed medication will do more harm than good?”

3) “Do you have financial issue related to your prescribed medication?”

The patient's responses to the above questions may comprise (but not limited to):

1) “I am convinced of the importance of my prescribed medication.”

2) “However, I worry that my prescribed medication will do more harm than good to me.”

3) “Furthermore, I feel financially burdened by my out-of-pocket expenses for my prescribed medication.”

It should be noted that the above questions and responses are only illustrative. The important aspect is that through these illustrative questions/answers, the patient is providing the barrier(s) that is the underlying cause for medication non-adherence for this particular patient. For example, the underlying causes, barriers, or perspectives may encompass: 1) a failure to understand or trust in the importance, effectiveness and/or efficacy of the medication, 2) a belief that the medication may be harmful, and 3) the cost of the medication is not affordable. It should be noted that this list of underlying perspectives responsible for medication non-adherence is only illustrative and should not be deemed to be exhaustive.

However, although understanding the underlying cause(s) as to why an individual is failing to follow the instructions for a prescribed medication is important, that knowledge alone is insufficient to bring about a change in the behavior of the individual. For example, if a patient states that “I am not convinced that I need to take the antibiotics for the full 10 days, especially I felt great after taking the medication for 5 days,” then one can assume that this individual's barrier to medication adherence is related to a failure to trust in the importance of finishing the full course of the medication. One can certainly address this individual's barrier by demonstrating to the individual the importance of finishing the full course of the medication, e.g., via published literature on why it is important to finish the full course of the medication, governmental statistics or studies on why it is important to finish the full course of the medication, and so on.

Although such approaches would appear on its face to solve the detected barrier to medication adherence for this particular individual, it may actually be ineffective. One reason is that medication non-adherence has been noted to be very personal to the patient. Namely, the reason(s) for medication non-adherence can be quite different from patient to patient. Thus, a simple solution of simply presenting generic refuting documentations to a patient is often ineffective in that no consideration is given to how such refuting documentations should be presented to the patient. One size does not fit all in the context of presenting medical information to a patient for the purpose of persuading a patient to bring about medication adherence.

The reason is that the proposed response (i.e., presenting refuting documentations) is essentially a repudiation of the individual's perspective, i.e., the response amounts to saying “no, you are thinking about it in the wrong way, and you need to think about it this way instead, which is the proper way.” Even if such generic response does in some way address the specific concern(s) of the patient, it is not tailored or presented to the specific patient in a custom way to ensure a greater chance of success. In other words, the patient does not feel that his or her concerns are taken seriously, thereby providing no motivation for the patient to change his or her behavior to bring about medication adherence.

Thus, one important aspect of addressing medication non-adherence is to first determine how information, e.g., medication information such as medication data sheets, medication instructions, medication studies, and the like, can be presented in a manner that will command the attention of the patients. In other words, each patient has a different preference in terms of how he or she prefers medical information to be presented (broadly information format). Similarly, each patient has a different preference in terms of how he or she prefers medical information to be delivered or conveyed to them (broadly communication modality).

For example, medication or pharmaceutical drug data sheets (broadly drug data sheets) contain very detailed prescribing information on a specific medicine. Such drug data sheets may contain a wealth of medical information, such as potential side effects or adverse reactions, clinical trial data, interaction of the drug with other medications, and so on. Typically, many of these drug data sheets are written in such a technical manner that only medical professionals will fully understand and appreciate all of the important medical information presented in the drug data sheets. Unfortunately, such overwhelming amount of medical information may have the exact opposite effect. In other words, the very goal of the drug data sheets to educate and inform the patient is not achieved because the drug data sheets are not tailored to any particular group of patients, i.e., accounting for education level, reading comprehension level, and the like. More importantly, the drug data sheets are not designed to account for the patient's subjective preference in terms of information format and/or communication modality). In other words, a patient may have the “objective” reading comprehension skill to understand the medical information, but the patient may still want medical information to be presented in a “subjective” information format that the patient is more comfortable with in digesting the medical information. Thus, it is not a question as the ability to understand the medical information, but a question as to whether the information is presented in a manner that will capture the attention of and be relevant to the patient to bring about medication adherence.

For example, a young patient (e.g., a teenager) may prefer medical information to be presented in a summary format, e.g., bar charts, pie graphs, and the like, and may prefer such summary format to be presented in an electronic form, e.g., accessible via a website, or delivered to their mobile endpoint devices, e.g., a mobile phone or a smartphone. In contrast, an elderly patient may prefer medical information to be presented in a detailed format, e.g., a written report with detailed statistical charts, and the like, and may prefer such medical information in detailed format to be presented in physical media form, e.g., a printed publication to be delivered by mail to the home of the patient.

Thus, knowing the information format and the communication modality that are preferred by each patient becomes an important aspect of addressing medication adherence. To deduce each patient's preference as to the information format and the communication modality is often a challenging endeavor. One can certainly present the patient with a survey that may have direct questions pertaining to information format and the communication modality. Unfortunately, the patient would be required to provide answers to a great number of questions. This is time consuming and potentially annoying to the patient and may risk losing the patient's attention, thereby resulting in gathering inaccurate data and ill will instead of rapport. Furthermore, surveys are notoriously inaccurate as survey takers frequently provide answers that are influenced by their projection of what the questioners want to hear. These factors (and others) result in the well know dichotomies between what people say in surveys and what they actually do—the difference between stated and revealed preference. Thus, it has been noted that patients often treat surveys with a cavalier attitude or simply provide aspirational answers that often mask the patients' true feeling or preferences.

In contrast, in one embodiment of the present disclosure, the method attempts to establish the patients' preference as to the information format and the communication modality in an engaging manner, e.g., using images to deduce the patients' mental state. More specifically, the method discloses the use of image based preference techniques to infer customers' preference for information format and communication modality.

In one embodiment, the present disclosure comprises a system in which patients are shown arrays of pictures, generally as groups of panels of similar pictures, and are asked to choose their “favorites” (or rank an order of their preference). From the analysis of the choice patterns, elements important to the establishment of a custom tailored communication scheme are deduced for each patient. For example, patients can be shown pictures of various modes of communication or of persons demographically similar to themselves engaged in the use of communication techniques. Such pictures can be shown in a context that indicates time of day and location (home in the evening, at work during the day, on the go, and so on) for further information specificity. This elicits a psychological frame that is more likely to be absent in the response to simple text question about communication preference. In addition, such a scheme allows the elucidation of context that would require many words or many questions to describe, resulting in a degradation of the reliability of the responses.

In a similar manner, images of various types of reading materials can be used to help elucidate the level of complexity and style preferences for written or other explanatory messages. A patient can be shown, for example images of various publications, e.g., USA Today, The Wall Street Journal, National Geographic, and other print resources and then asked to select a favorite will reveal information about his or her reading affinity and proficiency (e.g., reading grade level preference). It should be noted that this selection of preference is more germane to the targeting of suitable published material for a patient than an actual measurement of the maximum grade level reading competence since persons do not always prefer to operate at their maximum capability. In one embodiment, the inclusion in the image set of publications that have varying levels of analytics and pictorial content can also inform the choice of the style or format in which medical information is presented to the patient.

In medication adherence, it has been shown that three dimensions or factors can be used to assess the likelihood that a patient will have an adherence problem: 1) affordability, 2) safety, and 3) importance. One aspect of the present disclosure is to use the presentation of image panels for the elucidation of preferences to develop a custom patient profile for use in a patient engagement system that will bring about or ensure medication adherence. The present system and method are able to deduce a patient's preference as to information format and/or communication modality. Once the information format and/or communication modality are deduced for a particular patient, pertinent medical information are then presented to that particular patient in the deduced information format and/or communication modality. The present medical information can be tailored to address one or more of the noted three factors for causing medication non-adherence.

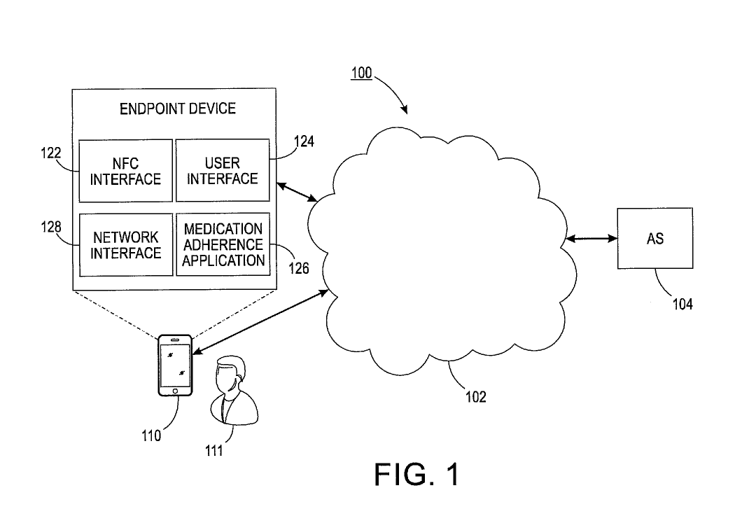

FIG. 1 illustrates an example system 100 of the present disclosure. The system 100 may include a network 102. In one embodiment, the network 102 may be a local network of a company or commercial enterprise. In another embodiment, the network 102 may be a network in the “cloud” or accessible over the Internet. In yet another example, network 102 may include a wireless access network, a mobile core network (e.g., a public land mobile network (PLMN)-universal mobile telecommunications system (UMTS)/General Packet Radio Service (GPRS) core network), and/or an Internet Protocol (IP) multimedia subsystem (IMS) network, and the like.

It should be noted that the network 102 is simplified for ease of explanation. The network 102 may include additional access networks or network elements (e.g., firewalls, border elements, gateways, application servers, and the like) that are not shown.

In one embodiment, a user or an individual (e.g., a patient) 111 is using an endpoint device, e.g., a mobile endpoint device 110. The user may be interested in using the services provided by an application server 104. In one embodiment, the application server 104 is a networked device that is capable of interacting with the network 102 over a wireless or wired connection. For example, application server 104 can be deployed with the method of the present disclosure as further discussed below.

In one embodiment, the endpoint device 110 may be any type of endpoint device (wired or wireless) that is used by a patient to access the services provided by the application server 104. The endpoint device 110 may include, for example, a mobile endpoint device (e.g., a smartphone, a cellular telephone, a laptop computer, a tablet computer, a watch, a pair of eye glasses and the like) or a wired endpoint device such as a desktop computer, a smart television and the like.

One embodiment of the present disclosure provides a system 100 where the endpoint device 110 is able to interact with the application server 104 to encourage medication adherence. In one embodiment, the endpoint device 110 comprises a wireless communication interface, e.g., a near field communication (NFC) interface 122, a user interface 124 (e.g., one or more displays), a medication adherence application or module 126, and a network interface 128 (e.g., one or more software applications such as browsers, interfaces and/or hardware components (e.g., transceivers) to interact with a network).

In one embodiment, the endpoint device 110 may initiate a connection with the application server 104. For example, the mobile endpoint device 110 may use network interface 128 to access one or more service features provided by the application server 104. In one embodiment, the application server 104 is operated by a doctor's office, a hospital, a medical insurance company, a pharmaceutical company, and/or a governmental agency that are interested in promoting medication adherence of patients. For example, the endpoint device 110 can be used by the user 111 to launch a medication adherence application 126 to provide various inputs to the application server 104 such as asking questions, answering questions, and the like to promote medication adherence. In one embodiment, the medication adherence application 126 is a program that can be downloaded from the application server 104 for the benefit of the user 111. The medication adherence application 126 may include features such as storing a schedule, e.g., a calendar, relating to the required prescribed medication that must be taken by the patient, tracking patient consumption of the prescribed medication in accordance with the schedule, and so on.

In one embodiment, the wireless communication interface, e.g., a near field communication (NFC) interface 122, can be used to interact with various tracking devices to confirm or ensure that the patient has taken the medication. For example, a pill bottle cap or a pill dispensing device may interact wirelessly with the wireless communication interface 122 to report each instance in which one or more pills were dispensed presumably to be taken by the patient. Similarly the patient's response to the reminders provided by the calendar application may be used to compile an approximate compliance metric. The reporting of these events can be monitored and tracked by the medication adherence application 126 of the endpoint device 110. In turn, the monitored activities or events associated with medication adherence can then be reported back to the application server 104, e.g., periodically in accordance with a predefined schedule or when polled by the application server 104. This allows the mobile device of the patient to be part of system that will encourage and monitor a patient's medication adherence. If the patient is detected to be failing to follow the prescribed instruction for a medication, the application server 104 with the assistance of the endpoint device 110 may provide a reminder that the patient has failed to adhere to the schedule prescribed for the medication. In addition to the reminder, the patient can be encouraged to reach out to a medical professional and/or the application server 104 to provide patient inputs as to why the patient has failed or is unwilling to adhere to the schedule prescribed for the medication. Such patient input when received in a timely manner, will allow server 104 to quickly deduce the cause of the medication non-adherence and to devise a possible remedy for the patient.

For example, the patient may provide patient input that indicates the patient is having financial trouble and has decided to temporarily stop taking the medication or to attempt to “stretch” the medication by skipping a few doses from time to time due to cost. Such behavior may bring about severe consequences to the patient or other individuals in the future. When such events are detected in a timely manner, the application server 104 may suggest alternative source of obtaining the medication at a lower cost, e.g., an online pharmacy company, a charity that may assist needy individuals in maintaining their medical treatments, an assistance program operated by the manufacturer of the medication who may be willing to provide medical loans or grants to needy individuals who are currently on the medication but are having financial difficulty in paying for the medication, and so on.

When the mobile endpoint device 110 connects to the application server 104 (either directly or via a communication network 102), the mobile endpoint device 110 may display a user interface (UI) 124 to the user. The UI may be a graphical user interface that includes inputs, commands or instructions that are associated with the application server 104. In one example, a list of questions can be presented on the user interface (UI) 124 to the user 111. The user interface (UI) 124 may also present a list of possible answers, e.g., in a pull down menu, that are correlated to the list of questions. The user interface (UI) 124 may also present a plurality of images as further discussed below.

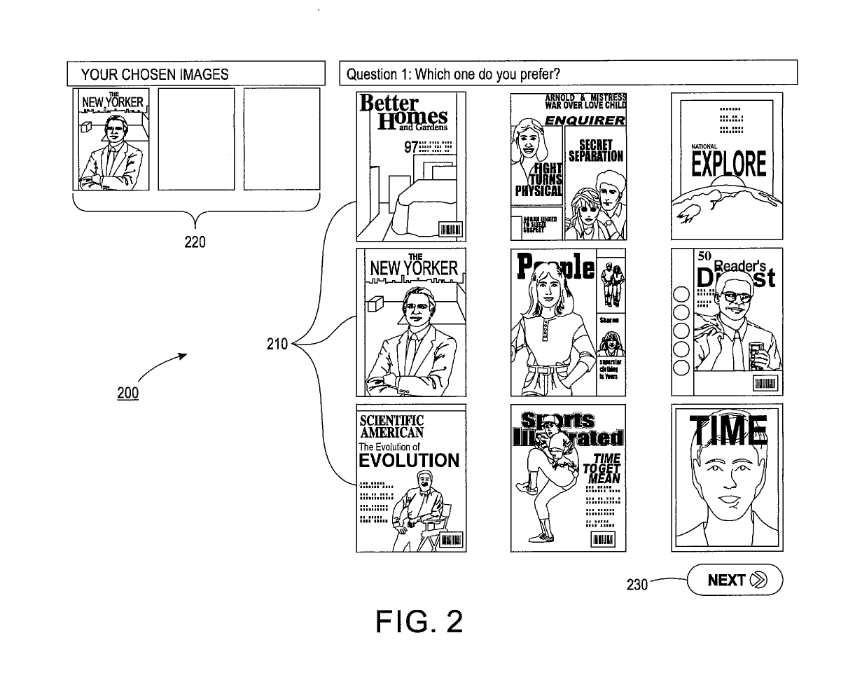

FIG. 2 illustrates an illustrative screen 200 of a first user interface to solicit a patient preference. FIG. 2 illustrates a plurality of images of various publications 210, e.g., Better Homes and Gardens, The New Yorker, Scientific American, The National Enquirer, People Magazine, Sports Illustrated Magazine, National Geographic, Reader's Digest, and Time Magazine. It should be noted that the above list of publications is only illustrative and not exhaustive and their illustrations in FIG. 2 are not intended to reflect the actual magazine covers of these publications. The illustrative screen 200 presents these images of various publications and requests that the patient chooses one of images for the purpose of creating a personalized experience in accessing the information, e.g., presented by a health wellness website or a private enterprise network, e.g., a private network of a pharmacy, a pharmaceutical company and the like. Once an image is selected as shown in chosen image section 220, the patient may click on a next button 230 to advance to the next set of images.

More specifically, the images presented in FIG. 2 are intended to elicit the patient's preference as to information format relating a “literacy comfort measure.” The “literacy comfort measure” comprises a measure as to the literacy format that the patient is comfortable in receiving published documents such as medical information to promote medication adherence. It is important to note that the “literacy comfort measure” is not intended to determine a patient's maximum literacy level. The goal is to determine the preference of the patient as to how medical information is to be presented, i.e., in what format. The set of images is used to quantify certain elements of an information format. In one embodiment, the information format may comprise: 1) a reading comprehension element (e.g., a measure of reading comprehension level or ability, e.g., middle school level, high school level, college level, or graduate school level), 2) a document element (e.g., a measure of the ability to locate and correlate information within a document or across multiple documents, and 3) a quantitative element (e.g., a measure of the ability to locate and use numerical or mathematical information). Each of these elements can be quantified with a numerical range, e.g., between 1-5 or 1-10, or with a relative range such as “high,” “medium,” and “low.” In one embodiment, instead of using relative measures such as a range of values, the quantitative element can be quantified in terms of how numerical information is to be presented, e.g., 1) equation format (e.g., showing actual mathematical equations or formulas), 2) table format (e.g., showing a grid format populated with numerical values, 3) graph format (e.g., showing a bar graph, a pie graph, or an x-y graph), 4) a 3-dimensional graph format (e.g., showing a 3-D bar graph coming out of a page), or 5) text format (e.g., showing the numerical information using text, e.g., in terms of sentences and paragraphs with minimal use of graphics such as tables or charts). Again, it should be noted that the above list of elements that are part of the information format is only illustrative and not exhaustive.

To illustrate, a patient may be deemed to prefer medical information to be presented in an information format comprising a reading comprehension element of “low”, a document element of “low” and a quantitative element of “high.” In other words, this particular patient wants the medical information to be presented using simplified language, e.g., using the generic term such as “antibiotic” instead of a particular scientific or a pharmaceutical term such as “azithromycin.” For this particular patient, any explanations as to the benefit or efficacy of the medication should be presented using simple terms. Furthermore, medical information should be presented in a short document (e.g., on a single sheet) in a concise manner so that the patient does not have to refer to different parts of the document to correlate the same information. Finally, for this particular patient medical information should be presented in quantitative terms whenever possible. Thus, the drug data sheet presented to this patient may only comprise a single sheet with many charts and tables to convey the benefit or efficacy of the medication in a concise manner but quantitatively.

In another example, a patient may be deemed to prefer medical information to be presented in an information format comprising a reading comprehension element of “high”, a document element of “high” and a quantitative element of “low.” In other words, this particular patient is comfortable with the medical information being presented in complex language e.g., using scientific or medical language, such as “azithromycin” instead of the generic term “antibiotic.” For this particular patient, explanations as to the benefit or efficacy of the medication can be presented using more complex terms and concepts. Furthermore, medical information can be presented in a longer document (e.g., having a plurality of sheets) where the patient can correlate the information across multiple sheets. Finally, for this particular patient medical information should not be presented in quantitative terms whenever possible. Thus, the drug data sheet presented to this patient may comprise multiple sheets with as few charts and tables as possible to convey the benefit or efficacy of the medication in a more detailed manner.

The above examples provide insights as to how different patients may want the same medical information but in completely different information format. The use of the set of images is intended to correlate the patient's preferences as to the reading comprehension element, the document element and the quantitative element of an information format. For example, the National Enquirer publication can be associated with the information format comprising a reading comprehension element of “low,” a document element of “low” and a quantitative element of “low,” whereas the Scientific American publication can be associated with the information format comprising a reading comprehension element of “high,” a document element of “high” and a quantitative element of “high.” In another example, the Sports Illustrated publication can be associated with the information format comprising a reading comprehension element of “medium,” a document element of “medium” and a quantitative element of “high” and so on for the other publications shown on FIG. 2.

It should be noted that the information format associated with each particular publication can be determined statistically over a period of time or over a large sample pool of patient inputs and feedbacks. In other words, the information format associated with each particular publication is determined subjectively over time based upon patients' inputs and feedbacks to ensure that selection of a particular publication will likely predict a patient's preference as to information format. Namely, if a patient is happy with the information formation chosen for him or her, then the preference prediction based on the selected image of a particular publication was accurate. However, if a patient is not satisfied with the information formation chosen for him or her, then the preference prediction based on the selected image of that particular publication was inaccurate. Over time, the present method, e.g., using a neural network platform, may adjust the preference correlation according to the patient feedbacks. It should be noted that images of newer publications can also be presented over time to ensure that the selected images are up to date and recognizable by the patients.

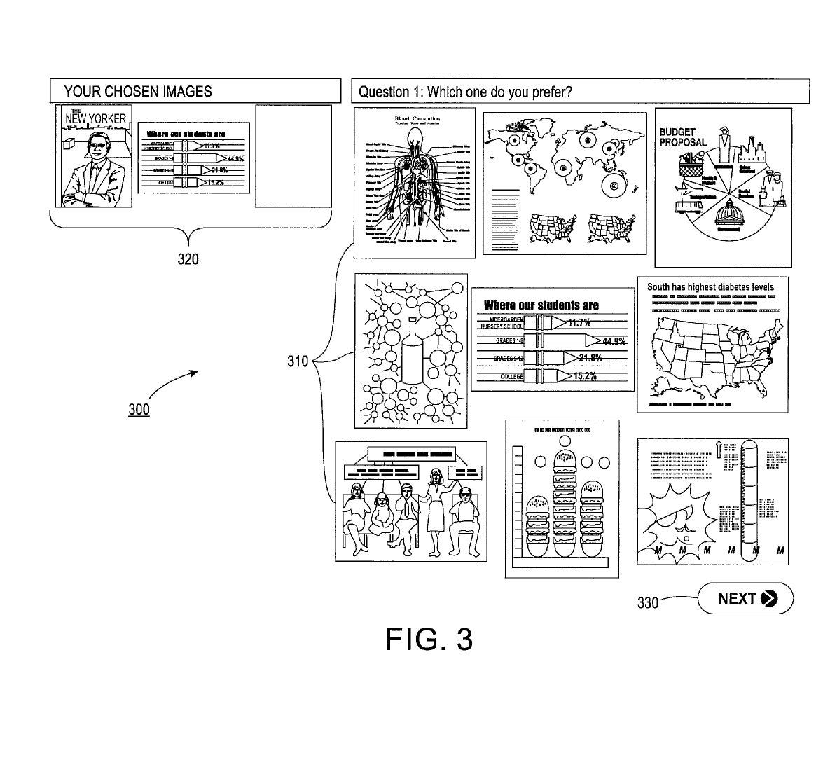

FIG. 3 illustrates an illustrative screen 300 of a second user interface to solicit a patient preference as related to numeracy or qualitative literacy. FIG. 3 illustrates a plurality of images 310 of various charts, tables, formulas, equations, and/or graphs. The illustrative screen 300 presents these images 310 of various charts, tables, formulas, equations, and/or graphs and requests that the patient chooses one of images for the purpose of creating a personalized experience in accessing the medical information. Once an image is selected as shown in chosen image section 320, the patient may click on a next button 330 to advance to the next set of images.

More specifically, the images presented in FIG. 3 are intended to elicit the patient's preference as to information format relating a “numeracy comfort measure.” The “numeracy comfort measure” comprises a measure as to the numeracy format that the patient is comfortable in receiving published documents such as medical information to promote medication adherence. It is important to note that the “numeracy comfort measure” is not intended to determine a patient's maximum numeracy level. The goal is to determine the preference of the patient as to how medical information is to be presented, i.e., in what format. The set of images are used to quantify certain elements of an information format, e.g., the quantitative element as discussed above.

For example, the quantitative element or numeracy comfort measure is intended to deduce the patient's preference as to how numeral information is to be presented. For example, one patient who has a “high” numeracy comfort level may be interested in seeing the equations or formulas that are responsible for various numerical statistics associated with medical information, or a patient may want to see the actual numbers for various particular medical parameters, e.g., “there were exactly 32,523 new cases of HIV infections reported in the month of May worldwide,” and so on. In contrast, another patient may only have a “low” numeracy comfort level such that the numeral information is presented only in simplified bar chart or pie chart format, e.g., showing a 67% pie wedge representing survival rate of individuals suffering from HIV infection who maintain medication adherence, with the remaining 33% pie wedge representing death rate of individuals suffering from HIV infection who did not maintain medication adherence, and so on. It should be noted that the examples provided above are only illustrative and should not be interpreted as actual medical statistics.

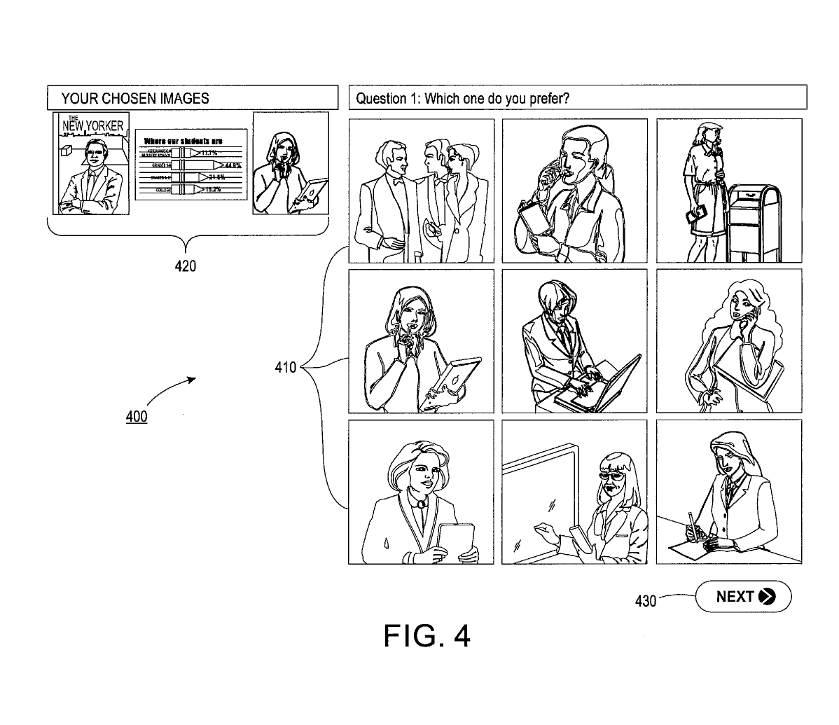

FIG. 4 illustrates an illustrative screen 400 of a third user interface to solicit a patient preference as related to communication modality. FIG. 4 illustrates a plurality of images 410 of various communication modalities, e.g., 1) in-person communication modality, 2) electronic communication modality, and 3) printed communication modality. For example, in-person communication may comprise speaking with a patient in person such as a face to face meeting with the patient in a doctor's office or having a phone conversation with the patient over a telephone. In another example, electronic communication may comprise interacting with the patient through email messages, text messages, medical discussion forums hosted on a website, social networking websites, health wellness websites hosted by hospitals, pharmaceutical companies, or doctor groups, websites with medical related videos or short programs that can be viewed by the patients, and the like. Medical information can be communicated electronically, e.g., as enclosures in emails or downloadable files obtained from various websites. In another example, printed communication may comprise letters, pamphlets or brochures sent through the mail (e.g., via a postal service). Again the above list of communication modalities is only illustrative and not exhaustive.

In one embodiment, each of the displayed images is correlated with one of the above listed communication modality. Once an image is selected as shown in chosen image section 420, the patient may click on a done button 430 to complete the process.

More specifically, the images presented in FIG. 4 are intended to elicit the patient's preference as to his or her comfort level relating to a particular communication modality. The goal is to determine the preference of the patient as the communication channel that will be preferred by the patient to receive the medical information. In other words, although it is important to send the medical information in an information format that will be well received by the patient, it is equally important to provide such medical information in a communication modality that the patient is comfortable in receiving the medical information. As discussed above, the goal is to promote medication adherence which requires a system to carefully address the concerns of the patient. By carefully presenting the medical information to the patient in an information format and a communication modality that have been deduced specifically for the patient will greatly encourage medication adherence. The patient will feel that the system has been customized to address the patient's specific concerns.

Thus, a pharmaceutical company, a hospital or a medical group of doctors may prepare a set of different drug data sheets in various different information formats. The set of different drug data sheets can be prepared such that each drug data sheet can be customized for a particular literacy level and/or numeracy level. Thus, once a particular literacy level and/or numeracy level are deduced for a particular patient, a corresponding drug data sheet can be presented to the patient in a communication modality favored by the patient, thereby increasing the likelihood of bringing about medication adherence.

As discussed above, any type of measures of literacy level and/or numeracy level can be used. The above set of examples is only illustrative. For example, the National Assessment of Adult Literacy (NAAL) Sponsored by the National Center for Education Statistics (NOES) comprises a comprehensive measure of adult literacy. NAAL has developed a method for measuring three types of literacy, e.g., Prose literacy (broadly the knowledge and skills needed to perform prose tasks), Document literacy (broadly the knowledge and skills needed to perform document tasks), and Quantitative literacy (broadly the knowledge and skills required to perform quantitative tasks). NAAL has also developed a set of parameters and measures for each of these three types of literacy. As such, the present disclosure can be modified to correlate the set of images illustrated in FIGS. 2-4 to reflect the three types of literacy developed by NAAL or any other organizations.

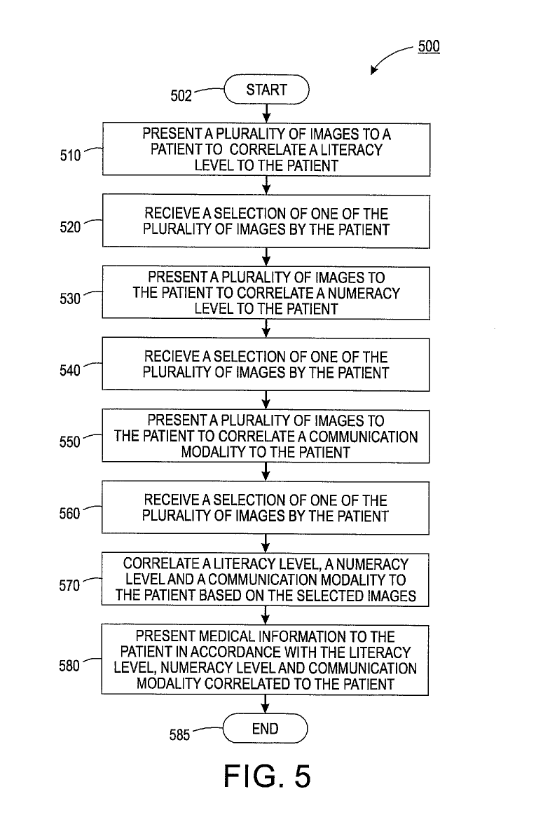

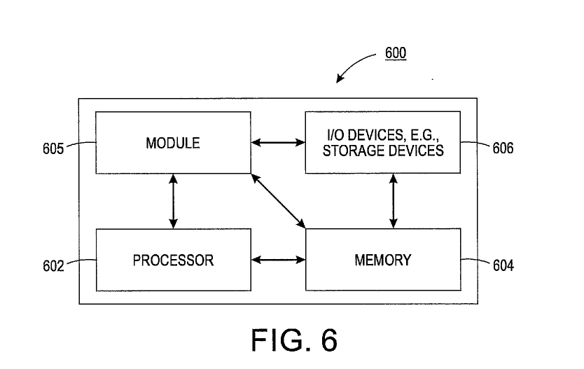

FIG. 5 illustrates an example flowchart of one embodiment of a method 500 for determining a patient's communication preferences (e.g., information format and communication modality) for promoting medication adherence. In one embodiment, one or more steps or operations of the method 500 may be performed by the endpoint device 110 or a computer as illustrated in FIG. 6 and discussed below.

At step 502 the method 500 begins. At step 510, the method 500 presents a plurality of images to a patient to correlate a literacy level of an information format for medical information to the patient. For example, the plurality of images as illustrated in FIG. 2 is presented to the patient for selection.

At step 520, the method 500 receives a selection by the patient of one or more of the plurality of the images presented to the patient. For example, the patient may click and drop an image to the section 220 of the screen 200 of FIG. 2. It should be noted that although only one image is illustrated as being selected by the patient in FIG. 2, the patient may be allowed to select additional images as alternates or “second” or “third” favorites.

At step 530, the method 500 presents a plurality of images to the patient to correlate a numeracy level of an information format for medical information to the patient. For example, the plurality of images as illustrated in FIG. 3 is presented to the patient for selection.

At step 540, the method 500 receives a selection by the patient of one or more of the plurality of the images presented to the patient. For example, the patient may click and drop an image to the section 320 of the screen 300 of FIG. 3. It should be noted that although only one image is illustrated as being selected by the patient in FIG. 3, the patient may be allowed to select additional images as alternates or “second” or “third” favorites.

At step 550, the method 500 presents a plurality of images to the patient to correlate a communication modality for communicating the medical information to the patient. For example, the plurality of images as illustrated in FIG. 4 is presented to the patient for selection.

At step 560, the method 500 receives a selection by the patient of one or more of the plurality of the images presented to the patient. For example, the patient may click and drop an image to the section 420 of the screen 400 of FIG. 4. Again, it should be noted that although only one image is illustrated as being selected by the patient in FIG. 4, the patient may be allowed to select additional images as alternates or “second” or “third” favorites.

In step 570, the method 500 correlates a literacy level, a numeracy level and/or a communication modality for the patient. Namely, based on the selected set of images, the method 500 will be able to deduce the literacy level, the numeracy level and the communication modality that the patient will be most comfortable in receiving medical information.

In step 580, the method 500 presents or provides the medical information, e.g., drug data sheet, in accordance with the literacy level, the numeracy level and the communication modality correlated or deduced for the patient. For example, a corresponding drug data sheet will be selected and presented to the patient that will match the patient's preference or comfort level as to information format and communication modality. In one embodiment, the medical information may comprise other type of information such as results of medical tests performed for the patient, e.g., blood test results, biopsy results, diagnostic test results such as radiology reports, cat-scan reports, magnetic resonance imaging (MRI) scan reports and the like. The method 500 ends in step 585.

Although not specifically shown in FIG. 5, various additional operations can be performed. For example, the correlated or deduced literacy level, numeracy level and communication modality can be presented back to the patient for the purpose of receiving feedback or confirmation. For example, method 500 may present the patient with a message, e.g., “We have determined that you prefer to receive medical information (e.g., drug data sheet) in a summary format with a limited amount of text combined with charts and tables that can be sent to you via an email with enclosure. Do you agree?” In turn, the patient can provide feedback to method 500 so that the correlation of the literacy level, the numeracy level and the communication modality can be made more accurate. Furthermore, the patient can be allowed to repeat steps 510-560 again if it is determined that the correlation needs further improvement. Furthermore, various steps of FIG, 5 can be deemed to be optional, e.g., the literacy level correlation steps, the numeracy level correlation steps or the communication modality correlation steps can be omitted. Finally, method 500 may be deployed as a part of a much larger or more comprehensive health monitoring system that may be tasked with monitoring medication adherence or more generally, monitoring the health wellness of a patient.

It should be noted that although not explicitly specified, one or more steps, functions, or operations of the method 500 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 5 that recite a determining operation, or involve a decision, do not necessarily require that both branches of the determining operation be practiced. In other words, one of the branches of the determining operation can be deemed as an optional step. In addition, it should be noted that FIG. 5 in some embodiments may be performed using any combination of the steps (e.g., using fewer than all of the steps) illustrated in FIG. 5 or in an order that varies from the order of the steps illustrated in FIG. 5.

It should be noted that the present method improves the field of medication adherence. Specifically, in one embodiment, the patient is encouraged to participate in formulating the patient's preference(s) associated with information format and communication modality for receiving medical information. In one embodiment, the present method utilizes a hardware system to automate the process of interacting with the patient through a presentation of series of images to uncover the underlying preferences of the patient with respect to information format and communication modality. It is believed that an improvement in the way medical information is presented to the patient will likely encourage medication adherence. Furthermore, the present method is able to transform responses and inputs provided by the patient into a determination as to the patient's preferences for information format and communication modality to advance medication adherence through customization of the medical information for each patient.

FIG. 6 depicts a high-level block diagram of a computer suitable for use in performing the functions described herein. As depicted in FIG. 6, the system 600 comprises one or more hardware processor elements 602 (e.g., a central processing unit (CPU), a microprocessor, or a multi-core processor), a memory 604, e.g., random access memory (RAM) and/or read only memory (ROM), a module 605 for promoting medication adherence, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements. Furthermore, although only one computer is shown in the figure, if the method(s) as discussed above is implemented in a distributed or parallel manner for a particular illustrative example, i.e., the steps of the above method(s) or the entire method(s) are implemented across multiple or parallel computers, then the computer of this figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 605 for determining a patient's communication preferences (e.g., a software program comprising computer-executable instructions) can be loaded into memory 604 and executed by hardware processor element 602 to implement the steps, functions or operations as discussed above in connection with the exemplary method 500. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for determining a patient's communication preferences (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method, comprising:
presenting, by a processor, a first plurality of images to a patient to correlate a literacy level to the patient;
receiving, by the processor, a first image selected by the patient;
presenting, by the processor, a second plurality of images to the patient to correlate a communication modality to the patient;
receiving, by the processor, a second image selected by the patient;
determining, by the processor, the literacy level and the communication modality for the patient based on the first image and the second image; and
presenting, by the processor, medical information to the patient in accordance with the literacy level and the communication modality.

2. The method of claim 1, further comprising:
presenting, by the processor, a third plurality of images to the patient to correlate a numeracy level to the patient;
receiving, by the processor, a third image selected by the patient; and
wherein the determining further comprises determining the numeracy level for the patient based on the third image.

3. The method of claim 2, wherein the presenting the medical information further comprises presenting the medical information in accordance with the numeracy level.

4. The method of claim 3, wherein the medical information comprises a drug data sheet.

5. The method of claim 4, wherein the first plurality of images comprises a plurality of images of publications.

6. The method of claim 1, wherein the communication modality comprises an in-person communication modality, an electronic communication modality, or a printed communication modality.

7. The method of claim 6, wherein the in-person communication modality comprises: a face to face meeting or a phone conversation over a telephone.

8. The method of claim 6, wherein the electronic communication modality comprises: an email message, a text message, or a discussion forum hosted on a website.

9. The method of claim 6, wherein the printed communication modality comprises: a letter, a pamphlet or a brochure sent via a postal service.

10. The method of claim 1, wherein the medical information is presented to promote medication adherence.

11. A non-transitory computer-readable medium storing a plurality of instructions which, when executed by a processor, cause the processor to perform operations, the operations comprising:
presenting a first plurality of images to a patient to correlate a literacy level to the patient;
receiving a first image selected by the patient;
presenting a second plurality of images to the patient to correlate a communication modality to the patient;
receiving a second image selected by the patient;
determining the literacy level and the communication modality for the patient based on the first image and the second image; and
presenting medical information to the patient in accordance with the literacy level and the communication modality.

12. The non-transitory computer-readable medium of claim 11, further comprising:
presenting a third plurality of images to the patient to correlate a numeracy level to the patient;
receiving a third image selected by the patient; and
wherein the determining further comprises determining the numeracy level for the patient based on the third image.

13. The non-transitory computer-readable medium of claim 12, wherein the presenting the medical information further comprises presenting the medical information in accordance with the numeracy level.

14. The non-transitory computer-readable medium of claim 13, wherein the medical information comprises a drug data sheet.

15. The non-transitory computer-readable medium of claim 14, wherein the first plurality of images comprises a plurality of images of publications.

16. The non-transitory computer-readable medium of claim 11, wherein the communication modality comprises an in-person communication modality, an electronic communication modality, or a printed communication modality.

17. The non-transitory computer-readable medium of claim 16, wherein the in-person communication modality comprises: a face to face meeting or a phone conversation over a telephone.

18. The non-transitory computer-readable medium of claim 16, wherein the electronic communication modality comprises: an email message, a text message, or a discussion forum hosted on a website.

19. A method, comprising:
presenting, by a processor, a first plurality of images to a patient to correlate a literacy level to the patient, wherein the first plurality of images comprises a plurality of images of publications;
receiving, by the processor, a first image selected by the patient;
presenting, by the processor, a second plurality of images to the patient to correlate a numeracy level to the patient;
receiving, by the processor, a second image selected by the patient;
presenting, by the processor, a third plurality of images to the patient to correlate a communication modality to the patient, wherein the communication modality comprises an in-person communication modality, an electronic communication modality, or a printed communication modality;
receiving, by the processor, a third image selected by the patient;
determining, by the processor, the literacy level, the numeracy level and the communication modality for the patient based on the first image, the second image and the third image; and
presenting, by the processor, a drug data sheet to the patient in accordance with the literacy level, the numeracy level, and the communication modality, wherein the drug data sheet is presented to promote medication adherence.

20. The method of claim 19, wherein the in-person communication modality comprises: a face to face meeting or a phone conversation over a telephone, wherein the electronic communication modality comprises: an email message, a text message, or a discussion forum hosted on a website, wherein the printed communication modality comprises: a letter, a pamphlet or a brochure sent via a postal service.
